(19) United States
(12) Patent Application Publication
(10) Pub. No.: US 2005/0212708 A1
(43) Pub. Date: Sep. 29, 2005

(54) Antenna configuration for wireless communication device

(75) Inventor: David Fifield, San Jose, CA (US)

Correspondence Address: GARLICK HARRISON & MARKISON LLP, P.O. BOX 160727, AUSTIN, TX, 78716-0727, US

(73) Assignee: Broadcom Corporation, Irvine, CA (US)

(21) Appl. No.: 10/810,112

(22) Filed: Mar. 26, 2004

(51) Int. Cl. H01Q 1/24

(52) U.S. Cl. 343/702

(57) ABSTRACT

An improved method and system for optimum placement of multiple antenna elements on circuit boards for wireless communication systems used in portable devices such as laptop computers and personal digital assistants (PDAs). Multiple antenna elements are placed on a circuit board with the individual antenna elements being placed such that they are orthogonal with respect to each other. In one embodiment of the present invention two antenna elements are placed on a circuit board in an orthogonal orientation to maximize the signal strength for an RF signal at a single frequency. In an alternate embodiment of the invention, four antenna elements are placed on the circuit board to maximize the signal strength for RF signals at two different frequencies. In the various embodiments of the present invention the gain characteristics of the various antenna elements are enhanced by placing the individual antenna elements in a predetermined orientation with respect to a ground plane on the circuit board. The placement of the antenna elements on a circuit board in accordance with the present invention maximizes signal strength by providing optimum spatial diversity and polarization diversity for the individual antenna elements. A wireless communication system implementing the present invention comprises a diversity switch that is operable to control which of the individual antenna elements is connected to the RF module of the wireless interface.

### RELATED APPLICATIONS

This application is related to U.S. patent application Ser. No. ______, filed concurrently herewith, entitled Shared Antenna Control by inventors Greg Efland and David Fifield, (Attorney Docket No. NP 3210) and is incorporated herein by reference in its entirety.

### BACKGROUND OF THE INVENTION

1. Field of the Invention

The present invention is directed in general to wireless communication systems. In one aspect, the present invention relates to a method and system for efficiently controlling multiple radio transceiver circuits.

2. Related Art

Communication systems are known to support wireless and wire-lined communications between wireless and/or wire-lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth (BT), advanced mobile phone services (AMPS), digital AMPS, global system for mobile communications (GSM), code division multiple access (CDMA), local multi-point distribution systems (LMDS), multi-channel-multi-point distribution systems (MMDS) and/or variations thereof.

Depending on the type of wireless communication system, a wireless communication device (such as a cellular telephone, two-way radio, personal digital assistant (PDA), personal computer (PC), laptop computer, home entertainment equipment, etc.) communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over the tuned channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switched telephone network, via the Internet, and/or via some other wide area network.

Wireless communication devices typically communicate with one another using a radio transceiver (i.e., receiver and transmitter) that may be incorporated in, or coupled to, the wireless communication device. The transmitter typically includes a data modulation stage, one or more intermediate frequency stages and a power amplifier. The data modulation stage converts raw data into baseband signals in accordance with a particular wireless communication standard. The intermediate frequency stages mix the baseband signals with one or more local oscillations to produce RF signals. The power amplifier amplifies the RF signals prior to transmission via an antenna. In direct conversion transmitters/receivers, conversion directly between baseband signals and RF signals is performed. The receiver is typically coupled to an antenna and includes a low noise amplifier, one or more intermediate frequency stages, a filtering stage and a data recovery stage. The low noise amplifier receives inbound RF signals via the antenna and amplifies them. The intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As the use of wireless communication devices increases, many wireless communication devices will include two or more radio transceivers with two or more antennas, where each radio transceiver is compliant with any of a variety of wireless communication standards may be used with the exemplary communication systems described herein, including Bluetooth, IEEE 802.11(a), (b), (g) and others. For instance, a computer may include two radio transceivers, one for interfacing with an 802.11a wireless local area network (WLAN) device and another for interfacing with an 802.11g WLAN device. In this example, the 802.11g transceiver operates in the 2.4 GHz frequency range and the 802.11a transceiver operates in the 5 GHz frequency range.

One of the problems faced by users of wireless communications devices is maintaining adequate signal strength to support the communication link. This problem is compounded by the use of portable devices such as laptop computers and personal digital assistants (PDAs) that are constantly being moved, thereby changing the orientation of the antennas used to receive the RF signals. As will be understood by those of skill in the art, RF signals have a polarization and the antenna must be properly oriented with respect to this polarization to maximize the signal strength. To maximize the likelihood of receiving a strong RF signal, many transceivers use multiple antenna elements that have physical characteristics that are tuned to maximize the RF signal strength at a particular frequency. However, prior art systems have not provided a system for ensuring proper orientation of antennas in portable wireless communication devices to ensure maximum RF signal strength.

In view of the foregoing, there is a need for an improved method and apparatus for orienting antennas on a circuit board to ensure maximum signal strength. Further limitations and disadvantages of conventional systems will become apparent to one of skill in the art after reviewing the remainder of the present application with reference to the drawings and detailed description which follow.

### SUMMARY OF THE INVENTION

Broadly speaking, the present invention provides an improved method and system for optimum placement of multiple antenna elements on circuit boards for wireless communication systems used in portable devices such as laptop computers and personal digital assistants (PDAs). In the present invention, multiple antenna elements are placed on a circuit board with the individual antenna elements being placed such that they are orthogonal with respect to each other. In one embodiment of the present invention two antenna elements are placed on a circuit board in an orthogonal orientation to maximize the signal strength for an RF signal at a single frequency. In an alternate embodiment of the invention, four antenna elements are placed on the circuit board to maximize the signal strength for RF signals at two different frequencies. In the various embodiments of the present invention the gain characteristics of the various antenna elements are enhanced by placing the individual antenna elements in a predetermined orientation with respect to a ground plane on the circuit board.

The placement of the antenna elements on a circuit board in accordance with the present invention maximizes signal strength by providing optimum spatial diversity and polarization diversity for the individual antenna elements. A wireless communication system implementing the present invention comprises a diversity switch that is operable to control which of the individual antenna elements is connected to the RF module of the wireless interface.

The objects, advantages and other novel features of the present invention will be apparent from the following detailed description when read in conjunction with the appended claims and attached drawings.

### BRIEF DESCRIPTION OF THE DRAWINGS

FIG. 1 is a schematic block diagram of a wireless communication system in accordance with the present invention.

FIG. 2 is a schematic block diagram of a wireless communication device in accordance with the present invention.

FIG. 3 is a schematic block diagram of a wireless interface device in accordance with the present invention.

FIG. 4 is a logic diagram of a method for sharing antenna control signals between wireless interface devices in accordance with the present invention.

FIG. 5 is a diagram of a circuit board comprising multiple antenna elements configured in accordance with the present invention.

The objects, advantages and other novel features of the present invention will be apparent from the following detailed description when read in conjunction with the appended claims and attached drawings.

### DETAILED DESCRIPTION

A method and apparatus for an improved wireless communication system is described. While various details are set forth in the following description, it will be appreciated that the present invention may be practiced without these specific details. For example, selected aspects are shown in block diagram form, rather than in detail, in order to avoid obscuring the present invention. Some portions of the detailed descriptions provided herein are presented in terms of algorithms or operations on data within a computer memory. Such descriptions and representations are used by those skilled in the field of communication systems to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that throughout the description, discussions using terms such as processing, computing, calculating, determining, displaying or the like, refer to the action and processes of a computer system, or similar electronic computing device, that manipulates and/or transforms data represented as physical, electronic and/or magnetic quantities within the computer system's registers and memories into other data similarly represented as physical quantities within the computer system memories or registers or other such information storage, transmission or display devices.

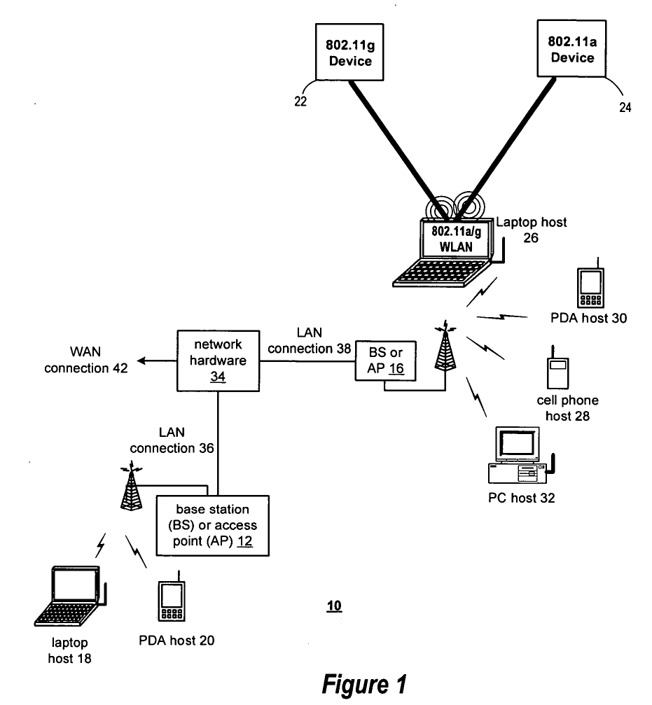

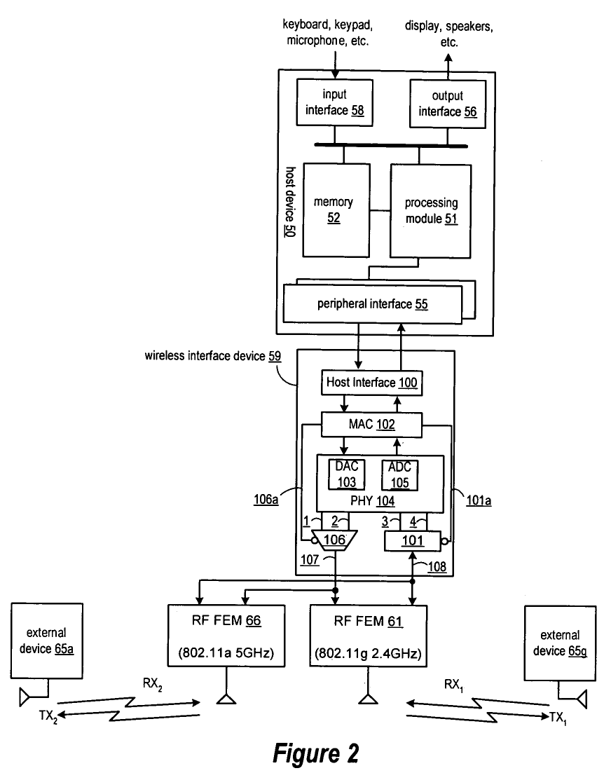

FIG. 1 illustrates a wireless communication system 10 in which embodiments of the present invention may operate. As illustrated, the wireless communication system 10 includes a plurality of base stations and/or access points 12, 16, a plurality of wireless communication devices 18-32 and a network hardware component 34. The wireless communication devices 18-32 may be laptop host computers 18 and 26, personal digital assistant hosts 20 and 30, personal computer hosts 32, cellular telephone hosts 28, an 802.11a WLAN device 22 and/or an 802.11g WLAN device 24. The details of the wireless communication devices will be described in greater detail with reference to FIGS. 2-4.

As illustrated, the base stations or access points 12, 16 are operably coupled to the network hardware 34 via local area network connections 36, 38. The network hardware 34 (which may be a router, switch, bridge, modem, system controller, etc.) provides a wide area network connection 42 for the communication system 10. Each of the base stations or access points 12, 16 has an associated antenna or antenna array to communicate with the wireless communication devices in its area. Typically, the wireless communication devices register with a particular base station or access point 12, 16 to receive services from the communication system 10. For direct connections (i.e., point-to-point communications), wireless communication devices communicate directly via an allocated channel. Regardless of the particular type of communication system, each wireless communication device includes a built-in radio and/or is coupled to a radio. The radio includes a highly linear amplifier and/or programmable multi-stage amplifier as disclosed herein to enhance performance, reduce costs, reduce size, and/or enhance broadband applications.

FIG. 2 is a schematic block diagram illustrating a radio implemented in a wireless communication device that includes the host device or module 50 and at least one wireless interface device, or radio transceiver 59. The wireless interface device may be built in components of the host device 50 or externally coupled components. As illustrated, the host device 50 includes a processing module 51, memory 52, peripheral interface 55, input interface 58 and output interface 56. The processing module 51 and memory 52 execute the corresponding instructions that are typically done by the host device. For example, in a cellular telephone device, the processing module 51 performs the corresponding communication functions in accordance with a particular cellular telephone standard. For data received from the wireless interface device 59 (e.g., inbound data), the peripheral interface 55 provides the data to the processing module 51 for further processing and/or routing to the output interface 56. The output interface 56 provides connectivity to an output display device such as a display, monitor, speakers, etc., such that the received data may be displayed. The peripheral interface 55 also provides data from the processing module 51 to the wireless interface device 59. The processing module 51 may receive the outbound data from an input device such as a keyboard, keypad, microphone, etc. via the input interface 58 or generate the data itself. For data received via the input interface 58, the processing module 51 may perform a corresponding host function on the data and/or route it to a wireless interface device 59 via the peripheral interface 55.

The wireless interface device 59 includes a host interface 100, a media-specific access control protocol (MAC) layer module 102, a physical layer module (PHY) 104, a digital-to-analog converter (DAC) 103, and an analog to digital converter (ADC) 105. Typically, transmit data coming from the host device 50 is presented to the MAC 102, which in turn presents it to the PHY 104. The PHY 104 processes the transmit data (scrambling, encoding, modulation, etc.) and then hands its output to the DAC 103 for conversion to an analog signal. The DAC output is then gained and filtered and passed to the antenna section 61 or 66 by way of the transmit signal path in line 108 using a routing or selection circuit 101 which acts to multiplex the actual transmit and receive (baseband analog) signals 3, 4 to a single signal 108 under control of a selection signal 101a. In addition, a selection circuit 106 is used to route two sets of antenna switch controls 1, 2 that are provided by the PHY 104 over a single output 107 (which may be a shared set of output pins or wires) under control of a selection signal 106a. The selection signal for selection circuit 101 (101a) and for selection circuit 106 (106a) may be generated by the MAC module 102. Depending upon the selection signal 106a provided by software, one of these controls 1,2 is output by the selection circuit 106 over a single set of pins/wires to control the antenna switches of both RF subsystems 61, 66. On the receive side, the antenna section (61 or 66) output is gained and filtered, then passed by way of the receive signal path in line 108 to an ADC 105 for conversion to a digital signal. This digital signal is processed (demapped, decoded, descrambled, etc.) by the PHY 104 and the bits are passed through the MAC 102 to the host 50 for delivery to the output interface 56. As will be appreciated, the modules in the wireless interface device are implemented with a communications processor and an associated memory for storing and executing instructions that control the access to the physical transmission medium in the wireless network.

In addition to a first radio transceiver circuit and RF front end 61 (that may or may not be integrated on a common substrate with the wireless interface 59), a second radio transceiver circuit and RF front end 66 is provided and coupled to the wireless interface device 59. For example, the first radio transceiver circuit and RF front end circuit 61 transforms baseband data into a 2.4 GHz signal in accordance with the 802.11g standard, while the second radio transceiver circuit and RF front end circuit 66 transforms baseband data into a 5 GHz signal in accordance with the 802.11a standard. With two separate radio transceiver circuits coupled to a wireless interface device 59, a single set of antenna switch control pins or wires 107 is used for connecting the antenna switch control signals 1, 2 with the transceiver circuits 61, 66 by using a multiplexer or selection circuit 106 to route the transceiver control signals 1, 2 to the appropriate transceiver circuit. For example, instead of having the wireless interface device 59 provide separate antenna switch control signals (and their attendant pin overhead for the device 59), the multiplexing of antenna control signals 1, 2 into a single set of pins/wires 107 (which are connected in parallel to both sets of antenna switches in the transceiver circuits 61, 66) reduces the pin count and overhead for the wireless interface device 59 without sacrificing performance.

Each external device (e.g., 65a, 65g) includes its own wireless interface device for communicating with the wireless interface device of the host device. For example, the host device may be personal or laptop computer and the external devices 65 may be a headset, personal digital assistant, cellular telephone, printer, fax machine, joystick, keyboard, desktop telephone, or access point of a wireless local area network. In this example, external device 65a is an IEEE 802.11a wireless interface device and external device 65g is an IEEE 802.11g wireless interface device.

In operation, interference between communications with external devices 65a, 65g is avoided where the external devices operating in different frequency ranges are prioritized or sequenced. As a result, when transmission or reception is occurring with a first external device (e.g., 65a), the radio transceiver circuit 61 for the second external device 65g is disabled and the antenna switch control signal (e.g., 1) for external device 65a is routed to the radio transceiver circuit 66 via multiplexer 106 under control of the selection signal 106a. Conversely, when transmission or reception is occurring with the second external device (e.g., 65g), the radio transceiver circuit 66 for the first external device 65g is disabled and the antenna switch control signal (e.g., 2) for external device 65g is routed to the radio transceiver circuit 61. The methods by which the MAC and/or PHY layer modules detect, adjust and/or route the antenna switch control signals 1, 2 may be executed by the processing module(s) and other transceiver module(s) included in the wireless interface device 59, or may alternatively be executed by the processing functionality in the host device 50.

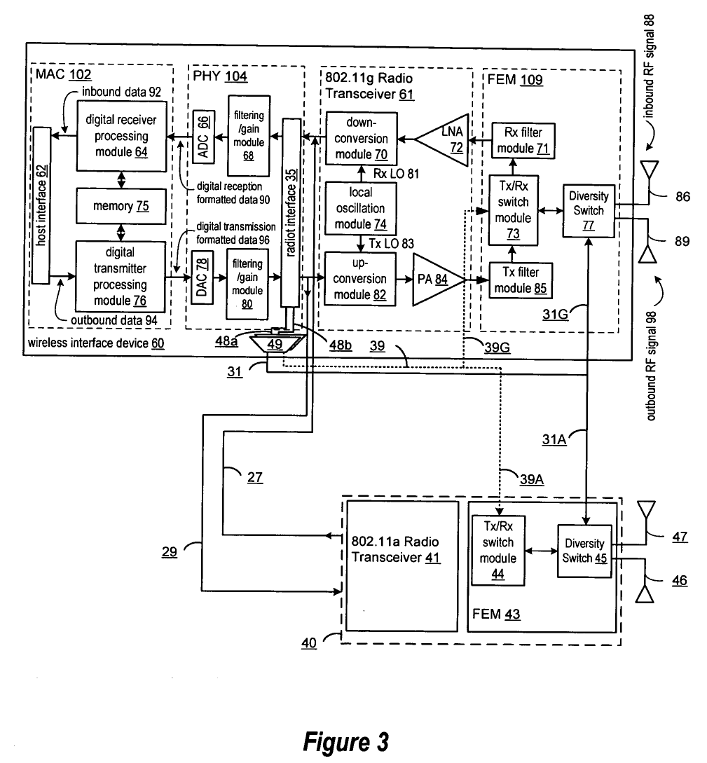

FIG. 3 is a schematic block diagram of a wireless interface device (i.e., a radio) 60 which includes a host interface 62, digital receiver processing module 64, an analog-to-digital converter (ADC) 66, a filtering/gain module 68, an down-conversion stage 70, a receiver filter 71, a low noise amplifier 72, a transmitter/receiver switch 73, a local oscillation module 74, memory 75, a digital transmitter processing module 76, a digital-to-analog converter (DAC) 78, a filtering/gain module 80, an mixing up-conversion stage 82, a power amplifier 84, a transmitter filter module 85 and a diversity switch 77. The transmitter/receiver switch 73 is coupled to the diversity switch 77 through which two antennas 86, 89 are coupled to the wireless interface device. As will be appreciated, the antennas 86, 89 may be polarized antennas, dual-band antennas with diplexors, directional antennas and/or may be physically separated to provide a minimal amount of interference. In addition, either antenna 86, 89 may be used for either transmitting or receiving signals, depending on the switching specified by the transmit/receive switch 73. As illustrated, the transmitter/receiver switch 73 and diversity switch 77 selectively couple one of the antennas 86, 89 to the transmit/receive switch 73 in response to a diversity switching control signal 31G that is provided by the PHY module 104. In addition, a transmit/receive switching control signal 39G may be provided by the PHY module 104 to the transmit/receive switch module 73. In a selected embodiment, the wireless interface device 60 uses the transceiver and antenna section (86, 89, 77, 73, 71, 72, 70, 74, 82, 84, 85) to receive and transmit signals in accordance with a first signaling protocol (e.g., IEEE 802.11g) under control of the PHY module 104.

To provide dual band communications, the wireless interface device 60 may be coupled to a second transceiver and antenna section 40 to receive and transmit signals in accordance with a second signaling protocol (e.g., IEEE 802.11a). As illustrated, transceiver and antenna section 40 includes a radio transceiver circuit 41 and front end modulator 43 for receiving and transmitting 802.11a signals, in this example. The front end modulator section may be constructed of a transmitter/receiver switch 44 and a diversity switch 45 for selectively coupling one of the antennas 46, 47 to the transmit/receive switch 44 in response to a diversity switching control signal 31A that is provided by the PHY module 104. In addition, a transmit/receive switching control signal 39A may be provided by the PHY module 104 to the transmit/receive switch module 44.

The above described antenna switch control signals are provided as a single output pin or wire from the PHY 104 by use of a multiplexing circuit 49. In particular, the diversity switch control signals 31A and 31G are provided as a single output from the multiplexer 49, which selects from the diversity switch control signals 48a, 48b under control of a multiplexer selection signal (not shown). Other control signals for the radio transceiver subsystems may also be provided by a single set of output wires or pins. For example and as indicated with the dashed lines, the transmit/receive switch control signals 39A and 39G may be provided as a single output from the multiplexer 49, which selects from the transmit/receive switch control signals 48a, 48b under control of a multiplexer selection signal (not shown). Other configurations of transmit/receive and diversity switches are possible, such as using a bridge configuration which directly implements the combined functions. In addition, each RF subsystem can be different, in which case the appropriate encoding of switch controls is used according to the active subsystem.

The digital receiver processing module 64, the digital transmitter processing module 76 and the memory 75 execute digital receiver functions and digital transmitter functions in accordance with a particular wireless communication standard. The digital receiver functions include, but are not limited to, digital baseband frequency conversion, demodulation, constellation demapping, decoding and/or descrambling. The digital transmitter functions include, but are not limited to, scrambling, encoding, constellation mapping, modulation and/or digital baseband frequency conversion. The digital receiver and transmitter processing modules 64, 76 may be implemented using a shared processing device, individual processing devices, or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry and/or any device that manipulates signals (analog and/or digital) based on operational instructions. The memory 75 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 64, 76 implements one or more of its functions via a state machine, analog circuitry, digital circuitry and/or logic circuitry, the memory storing the corresponding operational instructions may be embedded with the circuitry comprising the state machine, analog circuitry, digital circuitry and/or logic circuitry.

In operation, the wireless interface device 60 receives outbound data 94 from the host device via the host interface 62. The host interface 62 routes the outbound data 94 to the digital transmitter processing module 76, which processes the outbound data 94 to produce digital transmission formatted data 96 in accordance with a particular wireless communication standard, such as IEEE 802.11 (including all current and future subsections), Bluetooth, etc. The digital transmission formatted data 96 will be a digital base-band signal or a digital low IF signal, where the low IF typically will be in the frequency range of one hundred kilohertz to a few megahertz. Subsequent stages convert the digital transmission formatted data to an RF signal using a PHY module 104 and radio transmission circuitry, and may be implemented as follows. The digital-to-analog converter 78 converts the digital transmission formatted data 96 from the digital domain to the analog domain. The filtering/gain module 80 filters and/or adjusts the gain of the analog signal prior to providing it to the radio interface module 35. For transmission in accordance with a first signaling protocol (e.g., IEEE 802.11g), the radio interface module 35 provides the filtered/adjusted analog signal to the up-conversion module 82. The mixing stage 82 directly converts the analog baseband or low IF signal into an RF signal based on a transmitter local oscillation clock 83 provided by local oscillation module 74. The power amplifier 84 amplifies the RF signal to produce outbound RF signal 98, which is filtered by the transmitter filter module 85. Antenna switching control signals 39G, 31G provided to the transmit/receive switch module 73 and diversity switch module 77 route the outbound RF signal 98 for transmission to a targeted device such as a base station, an access point and/or another wireless communication device via a selected antenna 86, 89.

In accordance with a selected embodiment whereby a signal is to be transmitted in accordance with a second signaling protocol (e.g., IEEE 802.11a), the radio interface module 35 provides the filtered/adjusted analog signal 29 to the second transceiver and antenna section 40. As described herein, the actual transmit and receive (baseband analog) signals may be multiplexed between a first radio transceiver 61 and second radio transceiver 41 over a shared pin set using mux selection signals generated by the MAC module. (See selection circuit 101 in FIG. 2.) In addition to providing the filtered/adjusted analog signal 29 to the radio transceiver 41, antenna switching control signals 39A, 31A are provided to the transmit/receive switch module 44 and diversity switch module 45, which route the outbound RF signal from transceiver 41 for transmission to a targeted device such as a base station, an access point and/or another wireless communication device via a selected antenna 46, 47.

As illustrated in FIG. 3, the diversity switch control signals 31A, 31G are provided from a single set of output pins or wires 31 from the wireless interface device 60. This is made possible by including a signal selection circuit 49 for routing the appropriate diversity switch control signals 48a, 48b to the appropriate transceiver subsystem. The same technique can be used for other signals provided to the radio transceiver and FEM subsystems. For example, FIG. 3 shows that a single transmit/receive switch control signal 39 is coupled in parallel to the transmit/receive switch modules 44, 73 by using the signal selection circuit 49 to route the appropriate transmit/receive switch control signals 48a, 48b.

In accordance with a selected embodiment whereby a signal is to be received in accordance with a first signaling protocol (e.g., IEEE 802.11g), the wireless interface device 60 receives an inbound RF signal 88 from an antenna (e.g., 86) via antenna switch module(s) 73, 77, which was transmitted by a base station, an access point, or another wireless communication device. The inbound RF signal is converted into digital reception formatted data, either directly or through an intermediate frequency conversion process which may be implemented as follows. The diversity switch module 77 and transmit/receive switch module 73 provide the inbound RF signal 88 to the receiver filter module 71, where the receiver filter 71 bandpass filters the inbound RF signal 88. The receiver filter 71 provides the filtered RF signal to low noise amplifier 72, which amplifies the signal 88 to produce an amplified inbound RF signal. The low noise amplifier 72 provides the amplified inbound RF signal to the mixing module 70, which directly converts the amplified inbound RF signal into an inbound low IF signal or baseband signal based on a receiver local oscillation clock 81 provided by local oscillation module 74. The down conversion module 70 provides the inbound low IF signal or baseband signal to the filtering/gain module 68 via the radio interface 35. The filtering/gain module 68 filters and/or gains the inbound low IF signal or the inbound baseband signal to produce a filtered inbound signal. The analog-to-digital converter 66 converts the filtered inbound signal from the analog domain to the digital domain to produce digital reception formatted data 90. The digital receiver processing module 64 decodes, descrambles, demaps, and/or demodulates the digital reception formatted data 90 to recapture inbound data 92 in accordance with the particular wireless communication standard being implemented by wireless interface device. The host interface 62 provides the recaptured inbound data 92 to the host device (e.g., 50) via the peripheral interface (e.g., 55).

In accordance with a selected embodiment whereby a signal is to be received in accordance with a second signaling protocol (e.g., IEEE 802.11a), the radio interface module 35 receives the inbound low IF signal or baseband signal 27 from the second transceiver and antenna section 40. In addition to receiving the inbound low IF signal or baseband signal 27 from the radio transceiver 41, the radio interface 35 provides antenna switching control signals 39A, 31A to the transmit/receive switch module 44 and diversity switch module 45, which route the inbound RF signal from a targeted device via selected antenna 46, 47. Again, these control signals are provided from a common or shared device output. For example, the diversity switch control signal 31 is shared by the diversity switches 77, 45 which are coupled in parallel by lines 31G, 31A, respectively.

By distributing a antenna switching control signals 48a, 48b through a single set of output pines or wires (e.g., 31) from the radio interface 35 to the antenna sections of the first and second radio transceiver sections using a multiplexer or selection circuit 49, the overall pin count requirements for the wireless interface device 60 may be reduced. For example, instead of having one group of control pins on the wireless interface device 60 for controlling the diversity switch 77 in the first transceiver circuit 61, and another group of control pins on the wireless interface device 60 for controlling the diversity switch 45 in the second transceiver circuit 40, the present invention uses a single group of control pins 31 on the wireless interface device 60 for controlling both diversity switches 77, 45 by multiplexing the control signals 48a, 48b issued by the PHY module 104 through a selection circuit 49. The shared antenna control protocol does not affect the performance of a second transceiver circuit (e.g., 802.11a transceiver 40) when the first transceiver circuit (e.g., 802.11g transceiver 61) is active where the second transceiver circuit is disabled during transmit/receive operations of the first transceiver circuit. In a selected embodiment, the PHY module 104 provides the shared antenna control signals 48a, 48b through a selection circuit 49 to a single set of output pins 39 under control of the software operations that configure the system for transmit/receive operations under either a first protocol (e.g., the 802.11g protocol, whereby the second transceiver and antenna section 40 is disabled) or a second protocol (e.g., the 802.11a protocol, whereby the first transceiver and antenna section 61 is disabled).

As will be appreciated, the wireless communication device described herein may be implemented using one or more integrated circuits. For example, the host device 50 may be implemented on one integrated circuit, the digital receiver processing module 64, the digital transmitter processing module 76 and memory 75 may be implemented on a second integrated circuit, the remaining components of the wireless interface device 60 may be implemented on a third integrated circuit and the second transceiver and antenna section 40 may be implemented in a fourth integrated circuit. Alternatively, the MAC 102, PHY 104 and radio transceiver 61 may be implemented as one integrated circuit, the FEM 109 may be implemented as a second integrated circuit and the second transceiver and antenna section 40 may be implemented as a third integrated circuit. As another alternate example, the wireless interface device 60 may be implemented on a first integrated circuit and the second transceiver and antenna section 40 may be implemented in a second integrated circuit. As yet another example, the wireless interface device 60 and the second transceiver and antenna section 40 may be implemented in a single integrated circuit. In addition, the processing module 51 of the host device and the digital receiver and transmitter processing modules 64 and 76 may be a common processing device implemented on a single integrated circuit. Further, the memory 52 and memory 75 may be implemented on a single integrated circuit and/or on the same integrated circuit as the common processing modules of processing module 51 and the digital receiver and transmitter processing module 64 and 76.

In a selected embodiment, the present invention shows, for the first time, a fully integrated, single chip 802.11b/g solution with connectivity in the 2.4 GHz band, and with built-in support for 802.11a connectivity in the 5 GHz band, all implemented in CMOS (Complementary Metal Oxide Semiconductor), as part of a single chip or multi-chip transceiver radio using shared antenna control pins. The present invention enables wireless communication devices (such as a WLAN device) to communicate with other wireless devices by controlling multiple transceiver circuits (and their associated antenna switching circuitry) with a shared control signal when priority as between the competing WLAN devices has been allocated.

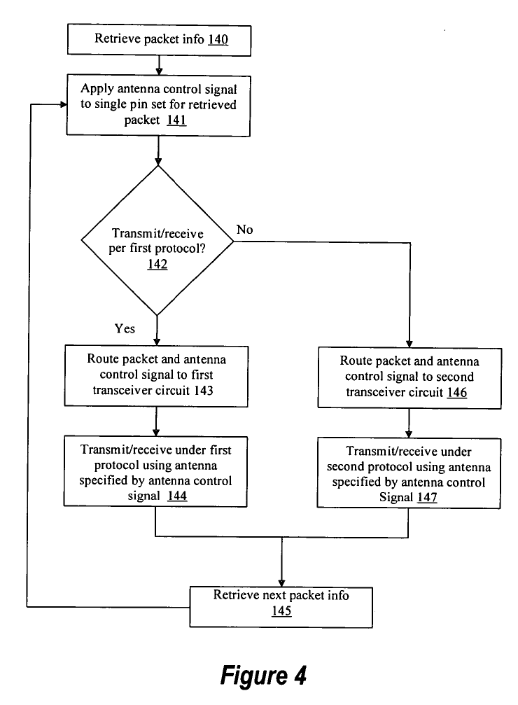

Turning now to FIG. 4, a method for controlling wireless communications with a plurality of external wireless devices is illustrated. The method begins at step 140, where packet information for the signal to be received or transmitted is retrieved. For example, a wireless interface device (e.g., 60) that is to transmit information retrieves packet data for the information from a host processor. To direct the transmission of the packet over a particular antenna, an antenna control signal is applied (step 141) to a predetermined pin set for the wireless interface device (e.g., 60). As described herein, this same pin set on the wireless interface device 60 is used for providing antenna control signals to both antenna sections, whether the transmission/reception is to be made by the first (e.g., 802.111g) transceiver or the second (e.g., 802.11a) transceiver.

At decision 142, it is determined which protocol is to be used for transmitting/receiving the packet. In a selected embodiment, this decision may be made by the PHY module 104. If a first protocol (e.g., 802.11g) is to be used (“yes” outcome from decision 142), the packet and antenna control signal are routed to the appropriate transceiver circuit (e.g., first transceiver circuit 61) at step 143. For example, a radio interface module 35 in the PHY module 104 selects one of the antenna switching control signal 48a, 48b for output to the first transceiver circuit with selection circuit 49, as illustrated in FIG. 3 with control line 31, 31G for the first diversity switch module 77. This same selection circuit is used to route the other of the antenna switching control signal 48a, 48b for output to the second transceiver circuit when it is to be used for transmitting or receiving data. Thus, the shared control lines (e.g., 31) specify a particular antenna (e.g., 86, 89) over which the transmit/receive operation is to occur in the first transceiver circuit 61 using the first protocol (step 144).

On the other hand, if it is determined at decision 142 that a second protocol (e.g., 802.11a) is to be used (“no” outcome from decision 142), the packet and antenna control signal are routed to the other transceiver circuit (e.g., second transceiver circuit 40) at step 146. For example, a radio interface module 35 in the PHY module 104 selects one of the antenna switching control signal 48a, 48b for output to the second transceiver circuit with selection circuit 49, as illustrated in FIG. 3 with control line 31, 31A for the second diversity switch module 45. Thus, the shared control lines (e.g., 31) specify a particular antenna (e.g., 46, 47) over which the transmit/receive operation is to occur in the second transceiver circuit 40 using the second protocol (step 147).

Upon completion of the transmission or reception of the packet, information for the next packet is retrieved (step 145) and the next antenna control signal for that packet is obtained from the single pin set (step 141). In this way, a single pin set on the wireless interface device 60 may be used to control antenna selection, regardless of which antenna group or signaling protocol is used.

As described herein and claimed below, a method and apparatus are provided for sharing selected transceiver control pins in a dual band wireless communication device. As will be appreciated, the present invention may be implemented in a computer accessible medium including one or more data structures representative of the circuitry included in the system described herein. Generally speaking, a computer accessible medium may include storage media such as magnetic or optical media, e.g., disk, CD-ROM, or DVD-ROM, volatile or non-volatile memory media such as RAM (e.g., SDRAM, RDRAM, SRAM, etc.), ROM, PROM, EPROM, EEPROM, etc., as well as media accessible via transmission media or signals such as electrical, electromagnetic, or digital signals, conveyed via a communication medium such as a network and/or a wireless link. For example, data structure(s) of the circuitry on the computer accessible medium may be read by a program and used, directly or indirectly, to implement the hardware comprising the circuitry described herein. For example, the data structure(s) may include one or more behavioral-level descriptions or register-transfer level (RTL) descriptions of the hardware functionality in a high level design language (HDL) such as Verilog or VHDL. The description(s) may be read by a synthesis tool which may synthesize the description to produce one or more netlist(s) comprising lists of gates from a synthesis library. The netlist(s) comprise a set of gates which also represent the functionality of the hardware comprising the circuitry. The netlist(s) may then be placed and routed to produce one or more data set(s) describing geometric shapes to be applied to masks. The masks may then be used in various semiconductor fabrication steps to produce a semiconductor circuit or circuits corresponding to the circuitry. Alternatively, the data structure(s) on computer accessible medium may be the netlist(s) (with or without the synthesis library) or the data set(s), as desired. In yet another alternative, the data structures may comprise the output of a schematic program, or netlist(s) or data set(s) derived therefrom. While a computer accessible medium may include a representation of the present invention, other embodiments may include a representation of any portion of the wireless communication device, transceiver circuitry and or processing modules contained therein.

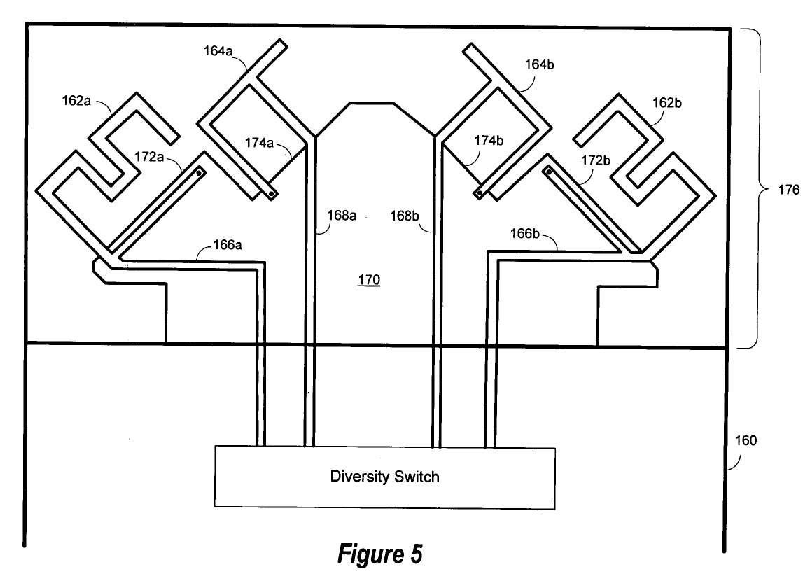

FIG. 5 is an illustration of a circuit board comprising multiple antenna elements oriented on a circuit board 160 in accordance with the present invention. The antenna elements comprise elements 162a and 162b that are optimized to receive RF signals at a first frequency and elements 164a and 164b that are optimized to receive RF signals at a second frequency. In one embodiment of the invention, the antenna elements 162a and 162b are optimized for RF signals at 2.4 GHz and the antenna elements 164a and 164b are optimized for RF signals at 5 GHz.

The elements 162a and 162b are connected to the diversity switch by wires 166a and 166b, respectively. Likewise the antenna elements 164a and 164b are connected to the diversity switch by wires 168a and 168b, respectively. The antenna elements 162a and 162b are oriented such that the elements are orthogonal to each other. Similarly, the elements 164a and 164b are also oriented such that the elements are orthogonal to each other. As will be appreciated by those of skill in the art, the orthogonal orientation of the element pairs provides the maximum polarization diversity of the element pairs, thereby enhancing the ability of the system to receive an RF signal from one of the elements. In addition, the individual antenna elements optimized for a particular frequency are located on opposite sides of the circuit board 160, thereby providing spatial diversity to optimize signal reception. For example, the individual antenna elements 162a and 162b that are on optimized for a first RF frequency, e.g. 2.4 GHz, are located on opposite sides of the circuit board 160. As discussed hereinabove, the diversity switch is operable to switch between each of the individual elements to select the element that is best oriented to receive the RF signal.

The signal reception is further enhanced by a ground plane 170 on the surface of the circuit board 160. The ground plane is configured to have a plurality of linear portions that oriented to enhance the signal reception of the associated antenna elements. As can be seen in FIG. 5, the linear portions 172a and 172b are each substantially parallel to the distal portions of the respective antenna elements 162a and 162b. In this configuration, the ground plane significantly enhances the signal reception of the individual antenna elements.

In one embodiment of the present invention the wireless system including circuit board and the antenna elements oriented thereon as described hereinabove are contained in a module such as a PCMCIA card that can be used in a laptop computer. In this embodiment, the antenna elements can be placed on a portion of the PCMCIA card 176 that is external to the laptop or PDA to increase the reception of RF signals.

While the system and method of the present invention has been described in connection with the preferred embodiment, it is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

1. A communication system for providing dual band wireless communications comprising:
a first radio transceiver operable to communicate using RF signals at a first frequency;
a second transceiver operable to communicate using RF signals at a second frequency;
a first pair of antenna elements for transmitting and receiving RF signals at said first frequency;
a second pair of antenna elements operable for transmitting and receiving RF signals at said second frequency; and
a diversity switch operably connected to said first and second transceivers and said first and second pairs of antenna elements, said diversity switch being operable to selectively direct RF signals at said first frequency between said first transceiver and said first pair of antenna elements and to direct RF signals at said second frequency between said second transceiver and said second pair of antenna elements;
wherein said first and second transceivers, said diversity switch and said first and second pairs of antenna elements are disposed on a circuit board whereby said individual elements of said first pair of antenna elements are disposed on said circuit board to optimize spatial diversity of said individual elements to optimize reception of said RF signals at said first and second frequencies.

2. The communication system according to claim 1, wherein said circuit board has first and second ends and first and second sides, wherein said individual elements of said first pair of antenna elements are disposed on said first end of said circuit board on opposite sides thereof and said second pair of antenna elements is disposed at said first end of said circuit board at opposite sides thereof.

3. The communication system according to claim 2, wherein said circuit board further comprises a ground plane disposed between said individual antenna elements on opposite sides of said circuit board.

4. The communication system according to claim 3, wherein said first and second elements of said first pair of antenna elements are oriented to maximize polarization diversity to optimize transmission and reception of said RF signals.

5. The communication system according to claim 4, wherein said first and second antenna elements are disposed on said circuit board with an orientation whereby said first and second antenna elements of said first and second pair are orthogonal with respect to each other.

6. The communication system according to claim 3, wherein said first and second elements of said second pair of antenna elements are oriented to maximize polarization diversity to optimize transmission and reception of said RF signals.

7. The communication system according to claim 4, wherein said first and second antenna elements of said second pair of antenna elements are disposed on said circuit board with an orientation whereby said first and second antenna elements of said second pair are orthogonal with respect to each other.

8. The communication system according to claim 5 wherein said first pair of antenna elements is optimized to operate at 2.4 GHz.

9. The communication system according to claim 7 wherein said second pair of antenna elements is optimized to operate at 5 GHz.

10. The communication system according to claim 5, wherein said circuit board having said first and second transceiver, said diversity switch and said first and second pair of antenna elements disposed thereon is housed in a PCMCIA module.

11. A method of providing dual band wireless communications comprising:
generating an RF signal at a first frequency using a first transceiver;
generating a second RF signal at a second frequency using a second transceiver;
using a diversity switch to selectively route said first RF signal at said first frequency to a first pair of antenna elements and to route said second RF signal at said second frequency to a second pair of antenna elements;
wherein said first and second transceivers, said diversity switch and said first and second pairs of antenna elements are disposed on a circuit board whereby said individual elements of said first pair of antenna elements are disposed on said circuit board to optimize spatial diversity of said individual elements to optimize reception of said RF signals at said first and second frequencies.

12. The method according to claim 11, wherein said circuit board has first and second ends and first and second sides, wherein said individual elements of said first pair of antenna elements are disposed on said first end of said circuit board on opposite sides thereof and said second pair of antenna elements is disposed at said first end of said circuit board at opposite sides thereof.

13. The method according to claim 12, wherein said circuit board further comprises a ground plane disposed between said individual antenna elements on opposite sides of said circuit board.

14. The method according to claim 13, wherein said first and second elements of said first pair of antenna elements are oriented to maximize polarization diversity to optimize transmission and reception of said RF signals.

15. The method according to claim 14, wherein said first and second antenna elements are disposed on said circuit board with an orientation whereby said first and second antenna elements of said first and second pair are orthogonal with respect to each other.

16. The method according to claim 15, wherein said first and second elements of said second pair of antenna elements are oriented to maximize polarization diversity to optimize transmission and reception of said RF signals.

17. The method according to claim 16, wherein said first and second antenna elements of said second pair of antenna elements are disposed on said circuit board with an orientation whereby said first and second antenna elements of said second pair are orthogonal with respect to each other.

18. The method according to claim 17, wherein said first pair of antenna elements is optimized to operate at 2.4 GHz.

19. The method according to claim 18, wherein said second pair of antenna elements is optimized to operate at 5 GHz.

20. The method according to claim 19, wherein said circuit board having said first and second transceiver, said diversity switch and said first and second pair of antenna elements disposed thereon is housed in a PCMCIA module.
